(19) United States
(12) Patent Application Publication
(10) Pub. No.: US 2023/0360401 A1
(43) Pub. Date: Nov. 9, 2023

(54) INVENTORY MANAGEMENT SYSTEM AND METHOD

(71) Applicant: Matthew HIPPENMEYER, Centerville, OH (US)

(72) Inventor: Matthew HIPPENMEYER, Centerville, OH (US)

(21) Appl. No.: 18/311,428

(22) Filed: May 3, 2023

Related U.S. Application Data
(60) Provisional application No. 63/337,982, filed on May 3, 2022.

(51) Int. Cl. G06V 20/50; G06V 10/147

(52) U.S. Cl. CPC G06V 20/50; G06V 10/147

(57) ABSTRACT

Inventory management systems and methods are provided for monitoring a desired inventory of materials stored in interiors of a plurality of bins.

### FIELD OF THE INVENTION

The field of the present invention relates to inventory management and, more particularly, to automated inventory management.

### BACKGROUND OF THE INVENTION

Many industries use bins on shelves or racks to organize and store materials. An example is the healthcare industry where hospitals typically have supply rooms that store disposable and consumable materials in bins. Inventories are maintained manually. That is, employees must count items within the bins in order to keep track of whether the bins are sufficiently full or require replenishment. This can be a laborious and tedious process.

Automated systems have been developed in other industries. One such automated system includes placing bins on scales. This system ascertains inventory level in the bins based on the weight of the bin as the weight is greatest when the bin is full and lightest when the bin is empty. However, such a system requires calibration to correlate the bin weight to the bin level as the relationship varies based on particular materials, and their associated individual weights, stored in the bins.

Another such automated system places pairs of infrared sensors on opposite sides of the bins at different heights so that the highest unbroken signal indicates the level of the material. However, such a system is not very accurate for very small materials unless a large number of sensors are utilized and is not very accurate for very tall products because one or a few products can block all of the sensors.

Accordingly, there exists a need for inventory management systems and methods that are less costly, more accurate, and easier to use than existing automated inventory management systems and methods.

### SUMMARY OF THE INVENTION

The present invention provides improved inventory management systems and methods which address at least one of the above-noted problems of the prior art.

Disclosed is an inventory management system for maintaining a desired inventory of materials stored in interiors of a plurality of bins. The inventory management system includes at least one conduit and at least one server. The at least one conduit has at least one lens for selectively obtaining at least one digital image of the interior of each bin of the plurality of bins, and a controller operably connected to the at least one lens for receiving the at least one digital image. The controller and the at least one lens are adapted for connection with a power source. The server selectively receives the at least one digital image from the controller and has at least one processor, a network interface in signal communication with the controller and the processor, and memory storing instructions. When the memory storing instructions are executed by the at least one processor, the server determines an amount of material within each bin interior of the plurality of bins.

Also disclosed is an inventory management method for maintaining a desired inventory of material stored in interiors of a plurality of bins The inventory management method comprising the steps of selectively obtaining at least one digital image of the interior of each bin of the plurality of bins using at least one lens provided in a conduit, wherein a controller is in communication with the at least one lens, receiving via a network interface in signal communication with the controller the at least one digital image from the controller at one or more servers, the controller having at least one processor and memory storing instructions, and executing the memory storing instructions by the at least one processor to determine from the at least one digital image an amount indicating quantity of material within each bin of the plurality of bins.

Also disclosed is an inventory management system for monitoring a desired inventory of materials stored in interiors of a plurality of bins. The inventory management system comprises at least one conduit having a plurality of lenses for selectively obtaining a plurality of digital images of the interior of each bin of the plurality of bins, a controller operably connected to the plurality of lenses for receiving the plurality of digital images, and wherein the controller and the plurality of lenses are adapted for connection with a power source. The inventory management system also comprises at least one server for selectively receiving the plurality of digital images from the controller and having at least one processor, a network interface in signal communication with the controller and the processor, and memory storing instructions that, when executed by the at least one processor, cause the server to determine from each of the digital images a value indicating quantity of material within each of the interiors of the plurality of bins.

From the foregoing disclosure and the following more detailed description of various preferred embodiments it will be apparent to those skilled in the art that the present invention provides a significant advance in the technology and art of inventory management systems and methods. Particularly significant in this regard is the potential the invention affords for providing reliable, inexpensive, convenient and effective systems and methods for automated inventory management. Additional features and advantages of the invention will be better understood in view of the detailed description provided below.

### BRIEF DESCRIPTION OF THE DRAWINGS

These and further objects of the invention will become apparent from the following detailed description.

FIG. 1 is a schematic view of an inventory management system according to one embodiment of the present invention.

FIG. 2 is a schematic view of an inventory management system according to another embodiment of the present invention.

FIG. 3 is a flow chart view of an inventory management method according to the present invention.

FIG. 4 is an illustrative flow chart view of an inventory management method according to the present invention.

It should be understood that the appended drawings are not necessarily to scale, presenting a somewhat simplified representation of various preferred features illustrative of the basic principles of the invention. The specific design features of the various inventory management systems as disclosed herein, including, for example, specific dimensions, orientations, locations, and shapes will be determined in part by the particular intended application and use environment. Certain features of the illustrated embodiments may have been enlarged or distorted relative to others to facilitate visualization and clear understanding.

### DETAILED DESCRIPTION

It will be apparent to those skilled in the art, that is, to those who have knowledge or experience in this area of technology, that many uses and design variations are possible for the systems and methods disclosed herein. The following detailed discussion of various alternative and preferred embodiments will illustrate the general principles of the invention. Other embodiments suitable for other applications will be apparent to those skilled in the art given the benefit of this disclosure.

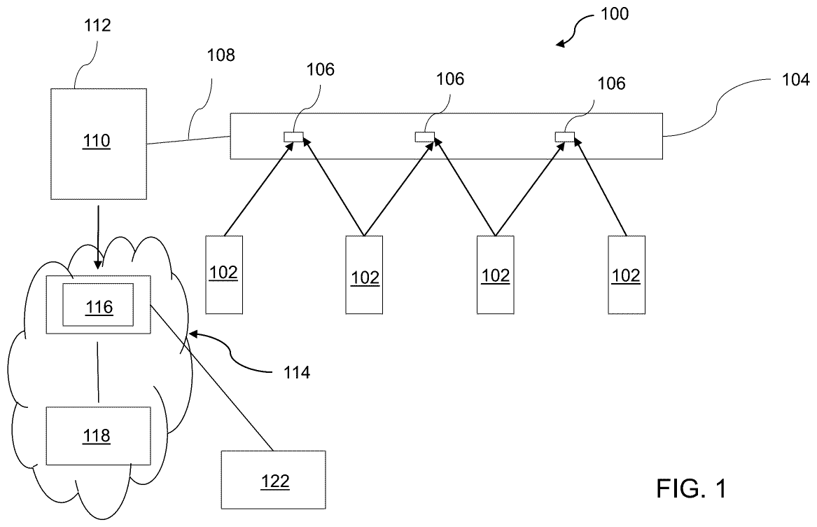

FIG. 1 illustrates an inventory management system 100 according to the present invention. The illustrated inventory management system 100 includes at least one conduit 104 and at least one server 114. Each conduit 104 has at least one lens 106 for selectively obtaining at least one digital image 108 of the interior of each bin 102 of a plurality of bins and a controller 110 operably connected to the at least one lens 106 for receiving the at least one digital image 108. The at least one lens 106 and the controller 110 are connected to a power source 112 for powering the at least one lens 106 and the controller 110. The at least one server 114 has at least one processor 116 and a network interface 118. The at least one server 114 selectively receives the at least one digital image 108 from the controller 110 via the network interface 118 and memory storing instructions. When the memory storing instructions are executed by the at least one processor 116, the inventory management system 100 determines a value indicating quantity of material within each of the plurality of bins 102 using the at least one digital image 108.

The illustrated conduit 104 includes a plurality of lenses 106 mounted at fixed and spaced-apart positions along the length of the conduit so that each lens of the plurality of lenses selectively takes a digital image 108 of the interior of one of the bins 102. In specific embodiments, the at least one digital image may refer to a single digital image of a bin taken by a lens, a plurality of digital images of a bin taken by a lens, a plurality of digital images of multiple bins taken by a lens, a plurality of digital images of one or more bins taken by multiple lenses, or other configurations as desired by a user of the inventory management system. In one embodiment, at least one lens comprises at least one rotatable lens for selectively obtaining the at least one digital image. In another embodiment, the conduit includes a single, rotatable lens that selectively takes a plurality of digital images of the interiors of multiple bins of the plurality of bins. In yet another embodiment, the conduit includes a plurality of rotatable lenses mounted at fixed and spaced-apart positions along the length of the conduit so that each lens selectively takes at least one digital image of the interior of one or more of bins, and/or where the rotatable lenses take multiple digital images, at different positions, of each interior of one or more bins. It is noted that one or more of the lenses can be positioned to provide digital images of more than one of the bins. In specific embodiments, one or more of the lenses can be a scanning-type digital camera positioned at a fixed location along the conduit, one or more digital cameras can be selectively moved along the length of the conduit by an electric motor, and/or one or more digital cameras can be both of a scanning type and selectively moved along the length of the conduit. The digital cameras can be of any suitable type and can take one or both of still digital images and video digital images.

In one embodiment, the controller selectively maintains approximately three to four lenses per conduit. In a specific embodiment, each conduit comprises a microprocessor, where one microprocessor can be used for the entire plurality of lenses on a conduit. Alternatively, where the lens comprises a digital camera, each digital camera may be maintained with a separate microprocessor. The microprocessor can be any embedded processor known in the art for supporting digital cameras and/or lenses.

The illustrated power source 112 provides electric power to the lenses 106, electric motors if any, and the controller 110. The illustrated power source is a rechargeable battery. However, the power source can alternatively be of any other suitable type such as, for example but not limited to, means for connecting to building AC power along with an AC/DC converter. The conduit can also be provided with card readers that selectively read employee badges when personnel of various enterprises are accessing the bins. It is noted that the conduit can have any other suitable configuration if desired.

In embodiments of the invention, the conduit includes a plurality of sensors mounted at fixed and spaced-apart positions along the length of the conduit so that each sensor detects a person located at each of the bins. It is noted however, that alternatively one or more of the sensors can be positioned to sense the presence of a person at more than one of the bins. The sensors can be of any suitable type such as, but not limited to, motion sensors, infrared sensors, and the like. The sensors can be in communication with the controller and/or the lenses so that the lenses take digital images when a person is at a bin and/or shortly thereafter. Additionally or alternatively, the controller and/or the digital lenses can be configured to take digital images of the bins at regularly scheduled times.

The illustrated server 114 includes a network interface 118 in communication with the controller 110, at least one processor 116, and memory storing instructions to be executed by the processor 116. The network interface 118 is a hard wired router that wirelessly communicates with both the controller 110 of the conduit 104 and, in a specific embodiment, also communicates with an Enterprise Resource Planning system (ERPS) 122 of a hospital or other institution. While an ERPS may specifically apply to a hospital setting, the inventory management system according to the invention may be used for a variety of industries such as manufacturing industries, retail industries, and others. It is noted that the network interface can alternatively be of any other suitable type and/or configuration. The memory storing instructions utilize machine learning (such as, for example, TensorFlow) and artificial intelligence to determine, from a digital image, an amount of material within each bin interior of the plurality of bins. Facial recognition software can also be provided if desired to determine who among personnel accessed the materials.

The amount of material within each bin interior of the plurality of bins may be presented in a variety of ways according to embodiments of the invention. In one embodiment, the memory storing instructions cause the server to determine whether each bin of the plurality of bins is empty or contains material. That is, the inventory management system determines, from a respective digital image, whether a particular bin either contains material, or is empty. The digital image may also capture a bar code, QR code, or similar identifying feature, to identify a respective bin and/or the particular material housed within the respective bin, and the server may then return said identifying information to an ERPS.

In another embodiment, the memory storing instructions cause the server to determine a percentage of material within each bin of the plurality of bins. That is, the inventory management system determines, from a respective digital image, a percentage of material within each bin. The inventory management system can determine whether each bin is 0% full, 25% full, 33% full, 50% full, 75% full, and/or 100% full of material, for example. The inventory management system can also be configured to determine any desired percentage of material within each bin of the plurality of bins. An ERPS can then utilize the percentage of material within each bin to determine when a certain category of material needs to be replenished based on stock need and use determined from the inventory management system.

In a further embodiment, the memory storing instructions cause the server to determine a value indicating quantity of material within each bin of the plurality of bins. That is, the inventory management system determines, from a respective digital image, a specific number of units of material within each bin.

In yet another embodiment, the memory storing instructions cause the server to determine a value indicating quantity of material within each bin of the plurality of bins from at least two points in time. The memory storing instructions are further configured to cause the server to determine a value indicating quantity of material removed from each bin of the plurality of bins within the at least two points in time. The inventory management system determines a value indicating quantity of material within each bin of the plurality of bins using the at least one digital image captured at a first time. The inventory management system then determines a value indicating quantity of material within each bin of the plurality of bins using the at least one digital image taken at a second time. The inventory management system then determines a value indicating quantity of material removed from each bin of the plurality of bins across the two points in time, from comparing the at least one digital image at the second time with the at least one digital image at the first time.

The inventory management system can be adapted with machine learning to send a report to a user of the inventory management system (such as through a hospital ERPS), allowing the customer to maintain information related to account management, insight, and related diagnostics revolving around the frequency of removal/use of materials from any number of bins included in the inventory management system. The machine learning aspect may be customizable to a user's preferences such as monitoring only specific bins, maintained by specific conduits and/or lenses, as well as adjusting frequency of the monitoring.

For example, the at least two points in time may comprise a difference of 1 hour, 2 hours, 4 hours, 8 hours, 1 day, 2 days, and/or 1 week, for example. This frequency in monitoring the material removed from each bin of the plurality of bins may be adjusted periodically, as frequent or infrequent as desired by a specific user.

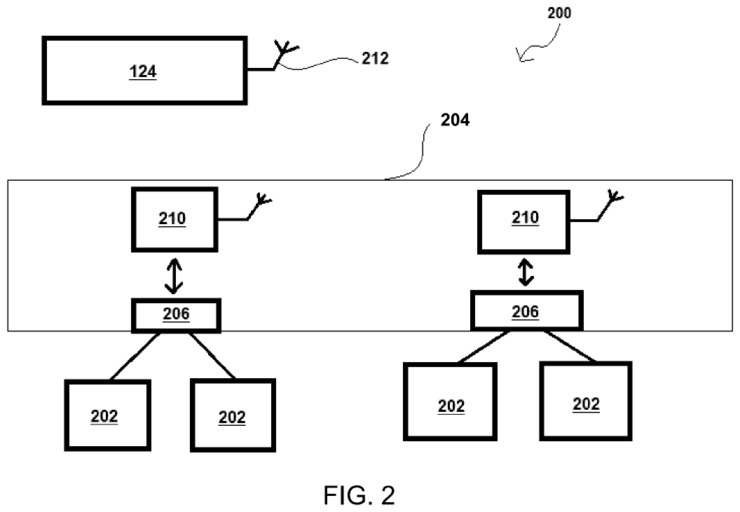

As shown in FIG. 2, in another embodiment of the invention, an inventory management system 200, includes at least one conduit 204 with its own microcontroller 210, a wireless transmitter 124, and a power source 212. The illustrated microcontroller 210 is configured to receive digital images from at least one lens 206 and push the digital images to a server as desired. The microcontroller may be used in conjunction with, or separately from, the controller of the whole inventory management system. It is noted that the digital images can be temporarily stored and sent to the server at desired intervals or sent to the microcontroller in real time. The lenses and/or the microcontroller are configured to provide a time/day/year for each of the digital images. The illustrated wireless transmitter 124 is an RF transmitter for wirelessly sending information to the server. It is noted that any other suitable type of wireless or wired communication between a controller/microcontroller and the server can alternatively be utilized. The illustrated power source 212 provides electric power to the lenses 206, electric motors if any, the microcontroller 210 and the wireless transmitter 124.

In one embodiment, the at least one conduit comprises a plurality of conduits, for example, 2 or more, 3 or more, 4 or more, or 5 or more conduits. In one embodiment, the at least one lens comprises a plurality of lenses, for example, 2 or more lenses, 3 or more lenses, or 4 or more lenses. In a specific embodiment, each conduit of the at least one conduit comprises 3 or more lenses. In another embodiment, each conduit comprises a camera strip that includes the plurality of lenses, a microprocessor wired to a multiplexer (mux) to connect the microprocessor to the rest of the inventory management system, a computing board, and/or lighting features for more accurate viewing of contents of the plurality of bins. The microprocessor may be any microprocessor known in the art assigned with a specific task, as opposed to a CPU or similar processor tasked with a variety of roles.

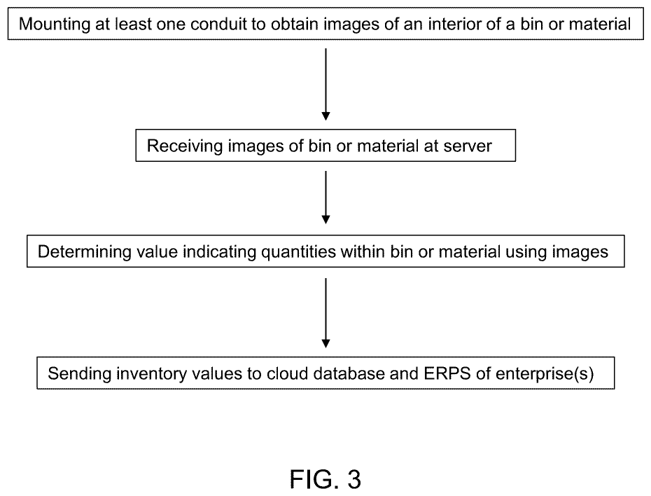

FIG. 3 illustrates an automated inventory management method according to the present invention. The illustrated automated inventory management method includes the steps of selectively obtaining at least one digital image of the interior of each of the plurality of bins. Each conduit has at least one lens and a controller in communication with the at least one lens. Next, the inventory management system receives the at least one digital image from the controller at one or more servers. Each server has at least one processor, a network interface in signal communication with the controller, and memory storing instructions. Next, the memory storing instructions are executed by the at least one processor to cause the inventory management system to determine, from the at least one digital image, a value indicating quantity of material within each of the plurality of bins. Finally, the inventory management system sends the inventory information including the quantity values from the server to the ERPS at the hospital or any other suitable enterprise. These steps are preferably performed in the order described above but it is noted that they can alternatively be performed in any other suitable order. It is noted that this method can additionally and/or alternatively have any other suitable steps.

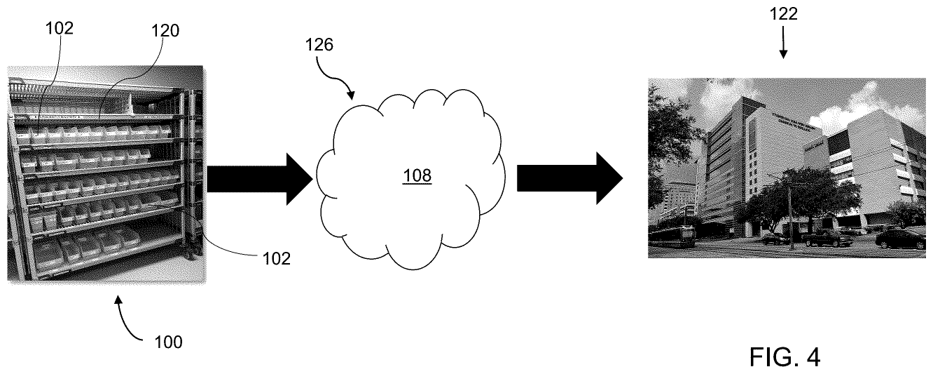

As demonstrated in FIG. 4, the inventory management system 100 selectively includes a plurality of shelves 120 for housing the bins. The plurality of bins 102 are stored on the plurality of shelves 120. In one embodiment, a conduit is arranged adjacent to each shelf of the plurality of shelves. Each conduit has a plurality of lenses for selectively obtaining the at least one digital image.

The conduit is generally linear to be mounted above and behind a row of bins supported on a shelf of the plurality of shelves, a rack, or similar structure. The conduit preferably extends the width of the shelf or rack. In a specific embodiment, the conduit is about 1 foot long to about 10 feet long, or about 2-8 feet long, or about 4-5 feet long. The conduit can alternatively have any other suitable shape and/or can be mounted in any other suitable location.

The bins may be varying sizes, quantities and/or shapes within individual shelves and/or across the inventory management system. When a lens captures at least one digital image 108 of an interior of a bin, the at least one digital image is processed using an embodiment of the inventory management system described herein. In specific embodiments, the bin information, such as a value of material in the respective bin is sent to an ERPS 122. For example, the bin information may be stored in a database 126 along with a bin number, product number, product name, time/date/year, identity of persons/employees accessing the bin, and/or any other desired information. The database may be a customer portal or any other in-house system used by a hospital or other suitable enterprise. The stored information sent to the ERPS can be used for processing of the bin information such as to monitor refill status of the respective bin or maintain orders of the material in each bin, at a hospital or any other suitable enterprise.

It is noted that each of the features of the various disclosed embodiments of the present invention can be utilized in any combination with each of the other disclosed embodiments of the present invention.

From the above disclosure it can be appreciated that the systems and methods according to the present invention can provide reliable, inexpensive, convenient and effective systems and methods for automated inventory management.

The preferred embodiments of this invention can be achieved by many techniques and methods known to persons who are skilled in this field. To those skilled and knowledgeable in the arts to which the present invention pertains, many widely differing embodiments will be suggested by the foregoing without departing from the intent and scope of the present invention. The descriptions and disclosures herein are intended solely for purposes of illustration and should not be construed as limiting the scope of the present invention.

What is claimed is:

1. An inventory management system for monitoring a desired inventory of materials stored in interiors of a plurality of bins, said inventory management system comprising, in combination:
at least one conduit having at least one lens for obtaining at least one digital image of the interior of each bin of the plurality of bins, a controller operably connected to the at least one lens for receiving the at least one digital image, wherein the controller and the at least one lens are adapted for connection with a power source; and
at least one server selectively receiving the at least one digital image from the controller and having at least one processor, a network interface in signal communication with the controller and the processor, memory storing instructions that, when executed by the at least one processor, cause the server to determine from each of the at least one digital image an amount of material within each bin interior of the plurality of bins.

2. The inventory management system of claim 1, wherein the memory storing instructions are further configured to cause the server to determine whether each bin of the plurality of bins is empty, or contains material.

3. The inventory management system of claim 1, wherein the memory storing instructions are further configured to cause the server to determine a percentage of material within each bin of the plurality of bins.

4. The inventory management system of claim 3, wherein the percentage of material within each bin of the plurality of bins is presented as at least one of 25% full, 50% full, 75% full, and/or 100% full of material.

5. The inventory management system of claim 1, wherein the memory storing instructions are further configured to cause the server to determine a value indicating quantity of material within each bin of the plurality of bins.

6. The inventory management system of claim 1, wherein the memory storing instructions are further configured to cause the server to determine a value indicating quantity of material within each bin of the plurality of bins from at least two points in time, and wherein the memory storing instructions are further configured to cause the server to determine a value indicating quantity of material removed from each bin of the plurality of bins within the at least two points in time.

7. The inventory management system of claim 6, wherein the at least two points in time comprise a difference of 1 hour, 2 hours, 4 hours, 8 hours, 1 day, 2 days, and/or 1 week.

8. The inventory management system of claim 1, wherein the at least one conduit comprises 3 or more conduits.

9. The inventory management system of claim 1, wherein the at least one lens comprises 3 or more lenses.

10. The inventory management system of claim 1, wherein each conduit of the at least one conduit comprises 3 or more lenses.

11. The inventory management system of claim 1, wherein the at least one lens comprises at least one rotatable lens for selectively obtaining the at least one digital image.

12. The inventory management system of claim 1, wherein the plurality of bins are stored on a plurality of shelves, wherein a conduit is arranged adjacent each shelf, and wherein each conduit has a plurality of lenses for selectively obtaining the at least one digital image.

13. An inventory management method for monitoring a desired amount of material stored in interiors of a plurality of bins, said inventory management method comprising the steps of, in combination:
selectively obtaining at least one digital image of the interior of each bin of the plurality of bins using at least one lens provided in a conduit, wherein a controller is in communication with the at least one lens;
receiving via a network interface in signal communication with the controller the at least one digital image from the controller at one or more servers, the controller having at least one processor and memory storing instructions; and
executing the memory storing instructions by the at least one processor to determine from the at least one digital image an amount of material within each of the plurality of bins using the at least one digital image of the interiors of the plurality of bins.

14. The inventory management method of claim 13, further comprising executing the memory storing instructions to determine whether each bin of the plurality of bins is either empty, or includes material, using the at least one digital image.

15. The inventory management method of claim 13, further comprising executing the memory storing instructions to determine a percentage of material within each bin of the plurality of bins using the at least one digital image.

16. The inventory management method of claim 15, wherein determining the percentage of material within each bin of the plurality of bins comprises determining whether each bin is 25% full, 50% full, 75% full, and/or 100% full of material.

17. The inventory management method of claim 13, further comprising executing the memory storing instructions to determine a value indicating quantity of material within each bin of the plurality of bins using the at least one digital image.

18. The inventory management method of claim 13, further comprising:
determining a value indicating quantity of material within each bin of the plurality of bins using the at least one digital image at a first time;
determine a value indicating quantity of material within each bin of the plurality of bins using the at least one digital image at a second time; and
determining a value indicating quantity of material removed from each bin of the plurality of bins from the at least one digital image at the second time compared to the at least one digital image at the first time.

19. The inventory management method of claim 13, further comprising rotating the at least one lens for selectively obtaining digital images of one or more interiors of the plurality of bins.

20. An inventory management system for monitoring a desired inventory of materials stored in interiors of a plurality of bins, said inventory management system comprising, in combination:
at least one conduit having a plurality of lenses for selectively obtaining a plurality of digital images of the interior of each bin of the plurality of bins, a controller operably connected to the plurality of lenses for receiving the plurality of digital images, and wherein the controller and the plurality of lenses are adapted for connection with a power source; and
at least one server selectively receiving the plurality of digital images from the controller and having at least one processor, a network interface in signal communication with the controller and the processor, memory storing instructions that, when executed by the at least one processor, cause the server to determine from each of the digital images an amount indicating quantity of material within each of the interiors of the plurality of bins.
